(19) United States
(12) Patent Application Publication
(10) Pub. No.: US 2022/0135123 A1
(43) Pub. Date: May 5, 2022

(54) AIR INJECTION MACHINE WITH PNEUMATIC POWER STEERING

(71) Applicant: FOLEY COMPANY, LLC, Prescott, WI (US)

(72) Inventors: Glen Black, Prescott, WI (US); Kurt D. Wullenweber, Prescott, WI (US)

(73) Assignee: FOLEY COMPANY, LLC, Prescott, WI (US)

(21) Appl. No.: 17/157,394

(22) Filed: Jan. 25, 2021

Related U.S. Application Data
(63) Continuation-in-part of application No. 16/949,444, filed on Oct. 29, 2020, now Pat. No. 11,072,365.

(51) Int. Cl. B62D 5/12; B62D 5/06; B62D 5/07

(52) U.S. Cl. CPC B62D 5/12; B62D 5/07; B62D 5/063

(57) ABSTRACT

One example provides a ride on air injection machine including one or more steerable wheels, a compressed air system providing compressed air, one or more air inject tines to inject compressed air from the compressed air system into the grounds, and a steering system. The steering system includes a steering wheel, a cylinder coupled to the steerable wheels, the cylinder including opposing internal chambers and being moveable to steer the steerable wheels and a control valve assembly to direct compressed air from the compressed air system to the internal chambers and to bleed compressed air from the internal chambers based on a position of the steering wheel to move the cylinder steer the steerable wheels.

### FIELD OF THE INVENTION

This disclosure relates generally to a machine for injecting air into soil to reduce soil compaction, increase porosity, and enhance respiration to enable water to drain easily and promote gas exchange with minimal disturbance to the overlying turf and roots and without soil cores. In particular, the invention relates to ride-on air injection machine having a pneumatic power steering system.

### BACKGROUND

A conventional steering system has four main parts: a steering column, a steering box, a steering linkage, and a steering knuckle. Added to the basic conventional steering system is a power assist system that makes it easier for the driver to steer the vehicle. Heretofore, power steering systems have been hydraulic, electrohydraulic, or electric.

Hydraulic power steering systems work by using a hydraulic system to multiply force applied to the steering wheel inputs to the vehicle's steered road wheels. A heavy and costly dedicated pump provides hydraulic pressure. The pump receives hydraulic fluid (power steering fluid) from a reservoir and supplies pressurized fluid to an actuator such as a double-acting hydraulic cylinder. The fluid may overheat and lose much of its lubricity and resistance to future overheating. Causes of overheating include pinched lines, low fluid levels, pump failure and hard driving. Additionally, over time the fluid entraps contaminants, including particles from seals, metal particles from plumbing and equipment, and environmental contaminants. Contaminated fluid can compromise performance, clog the power steering system and damage components such as bearings and seals.

Electric power steering use more than a just a motor. Complex and costly electronics, including a module containing drivers, signal generators and MOSFET switches that power and control the electric motor, a steering angle sensor that measures steering wheel position angle and rate of turn, and a Hi-Speed CAN bus on the vehicle for network communication of information, are used in such systems. It is impractical to incorporate these costly and complex electronics into certain vehicles.

Some vehicles include pneumatic pumps. In such vehicles, adding a hydraulic pump or electric motor and associated electronics for power assisted steering is inefficient. The electric motor and electronics increases complexity and cost while requiring a robust alternator or generator. A more powerful generator depletes engine power to meet the electric demands of the added motor and electronics. Likewise, a hydraulic pump consumes engine power and reduces efficiency, increases cost and complexity and increases weight. Problems associated with power steering fluid, as described above, also arise.

What is needed is an alternative power assist system for power steering. The system should obviate an electric pump, hydraulic pump and power steering fluid.

The invention is directed to overcoming one or more of the problems and solving one or more of the needs as set forth above.

### SUMMARY

One example provides a ride on air injection machine including one or more steerable wheels, a compressed air system providing compressed air, one or more air inject tines to inject compressed air from the compressed air system into the grounds, and a steering system. The steering system includes a steering wheel, a cylinder coupled to the steerable wheels, the cylinder including opposing internal chambers and being moveable to steer the steerable wheels and a control valve assembly to direct compressed air from the compressed air system to the internal chambers and to bleed compressed air from the internal chambers based on a position of the steering wheel to move the cylinder steer the steerable wheels.

Additional and/or alternative features and aspects of examples of the present technology will become apparent from the following description, the accompanying drawings and the appended claims.

To solve one or more of the problems set forth above, in an exemplary implementation of the invention, a pneumatic power steering system includes a source of compressed air, a directional control valve assembly fluidly coupled to a double acting cylinder with a through rod, a spring biased actuator coupled to a control shaft of the directional control valve assembly and also coupled to a linkage from a steering column. A piston is attached to the through rod, within the cylinder. The spring biased actuator pivots in proportion to rotation of the steering column. Pivoting of the spring biased actuator pushes or pulls the control shaft of the directional control valve assembly. The control shaft has three positions, a neutral position between an in position and an out position. In the neutral position, compressed air from the compressed air source enters the valve assembly and is directed to both sides of the piston, equally. Pushing or pulling of the control shaft causes movement of the cylinder of the double acting cylinder relative to the through rod by creating a pressure differential in the cylinder, with lower pressure on the side of the piston towards which the cylinder moves. Movement of the control shaft to the in-position causes the control valve assembly to bleed air from one side of the piston, the side to which the cylinder moves. Movement of the control shaft to the out-position causes the control valve assembly to bleed air from the other side of the piston. The spring of the spring biased actuator allows the control shaft to return to a neutral position when turning of the steering column ceases. Pivoting of the spring biased actuator compresses a spring in the actuator. When the steering wheel is returned to the straight position, the spring expands (de-compresses). Such expansion urges the actuator arm and control shaft to the center, the neutral position, where the valve assembly restores equal pressure on both sides of piston. In the neutral position, pressure on each side of the piston is equal. The cylinder, being coupled to the steering system, provides power assist.

In a non-limiting exemplary embodiment, a pneumatic power steering system according to principles of the invention includes a pneumatic valve assembly receiving compressed air from a compressed air source. A pneumatic cylinder is fluidly coupled to the pneumatic valve assembly. The pneumatic cylinder is a through-rod double-acting cylinder and includes a cylinder housing having a first end and a second end. The first rod end is opposite the second rod end. The first rod end extending from the first end. The second rod end extends from the second end. The first rod end and the second rod end are restrained from linear motion. Instead, the cylinder housing is movable linearly relative to the first rod end and the second rod end. The valve assembly controls motion of the cylinder housing relative to the first rod end and the second rod end. A first steering tie rod mount and a second steering tie rod mount are coupled (connected directly or indirectly) to the cylinder housing. A first tie rod extends from the first steering tie rod mount to a first steering knuckle. A second tie rod extends from the second steering tie rod mount to the second steering knuckle.

The valve assembly includes a control input (an input mechanism for controlling operation of the valve assembly). The control input is movable between a first position and at least one other position. In the first position the valve assembly causes motion of the cylinder housing towards the first rod end. The at least one other position may include a second position and a third position. In the third position the valve assembly causes motion of the cylinder housing towards the second rod end. In the second position the valve assembly causing the cylinder housing to cease motion relative to the first rod end and the second rod end.

An actuator assembly may be operably coupled to the control input of the valve assembly. The actuator assembly is pivotally mounted (directly or indirectly) to the cylinder housing. The control input of the valve assembly may include a control shaft. The actuator assembly may be operably coupled to the control input of the valve assembly by a coupling extending from the actuator assembly to the control shaft, whereby pivoting motion of the actuator assembly causes motion of the control shaft. The actuator assembly may also include an actuator arm. The actuator arm may include a steering link mount. An articulated steering linkage assembly (i.e., a multicomponent assembly connecting the output of a steering column to the steering link mount and consisting of segments or components united by joints, which may be movable joints) may be connected to the steering link mount and to a steering column (a shaft that rotates as the steering wheel or handlebar is rotated). The actuator assembly may also include a cavity containing a compression spring. The compression spring is compressible in the cavity. The cavity includes a plurality of adjoining slots. A pair of spaced apart uprights extend from the plate and are aligned with opposite ends of the compression spring through two of the plurality of adjoining slots. Thus, motion of the steering column causes related motion of the actuator assembly.

The first steering tie rod mount and the second steering tie rod mount may be formed in a plate (e.g., a power steering plate). The plate may be attached (directly or indirectly) to the cylinder housing. The valve assembly may be attached to the plate. The actuator assembly may be pivotally mounted to the plate.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a perspective view of an exemplary pneumatic power assist steering system connected to an axle assembly according to principles of the invention.

FIG. 2 is a perspective view of an exemplary pneumatic power assist steering system according to principles of the invention.

FIG. 3 is a plan view of an exemplary pneumatic power assist steering system connected to an axle assembly according to principles of the invention.

FIG. 4 is a perspective view of an exemplary cylinder housing mount for an exemplary pneumatic power assist steering system according to principles of the invention.

FIGS. 5-7 are perspective views of an exemplary spring-biased actuator assembly for an exemplary pneumatic power assist steering system according to principles of the invention.

FIG. 8 is a perspective view of an exemplary axle assembly pivotally mounted to frame components for an exemplary pneumatic power assist steering system according to principles of the invention.

FIG. 9 is a perspective view of an exemplary steering linkage for an exemplary pneumatic power assist steering system according to principles of the invention.

FIG. 10 is a perspective view of an exemplary double acting cylinder with a through rod for an exemplary pneumatic power assist steering system according to principles of the invention.

FIG. 11 is a perspective view of an exemplary valve assembly for an exemplary pneumatic power assist steering system according to principles of the invention.

FIG. 12 is a block and schematic diagram generally illustrating a ride on air injection machine including a pneumatic power assist steering system, according to one example of the present disclosure.

FIGS. 13A-13B are perspective views illustrating a ride on air injection machine including a pneumatic power assist steering system, according to one example of the present disclosure.

FIGS. 14A-14B are top views illustrating a ride on air injection machine including a pneumatic power assist steering system, according to one example of the present disclosure.

FIG. 15 is a perspective view illustrating portions of a ride on air machine a pneumatic power assist steering system, according to one example of the present disclosure.

FIG. 16 is a block and schematic diagram generally illustrating portions of a ride on air inject machine including a pneumatic power assist steering system, according to one example of the present disclosure.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

An exemplary pneumatic steering system according to principles of the invention includes a pneumatic cylinder movable in relation to a through-rod, steering tie rods coupled to the cylinder, a control valve assembly that controls motion of the cylinder in relation to the through-rod, a spring-biased pivoting actuator operably coupled to a steering linkage and to a control input of the control valve. The steering linkage is an articulated assembly that transforms rotation of the steering column to pivoting movement of the actuator.

A pneumatic power steering system according to principles of the invention requires pressurized gas from a source of pressurized gas, preferably a source of pressurized air. The source may comprise a tank containing pressurized air and/or a compressor that supplies compressed air to the tank or directly to the power steering system. The compressor may be driven by an electric motor or an internal combustion engine. In a vehicle equipped with an internal combustion engine, a belt and pulley coupled to the engine output may drive the compressor. The particular source of compressed air is not important, provided that source provides a sufficient volume of pressurized air at a pressure suitable for the valve assembly and pneumatic cylinder to provide power assist.

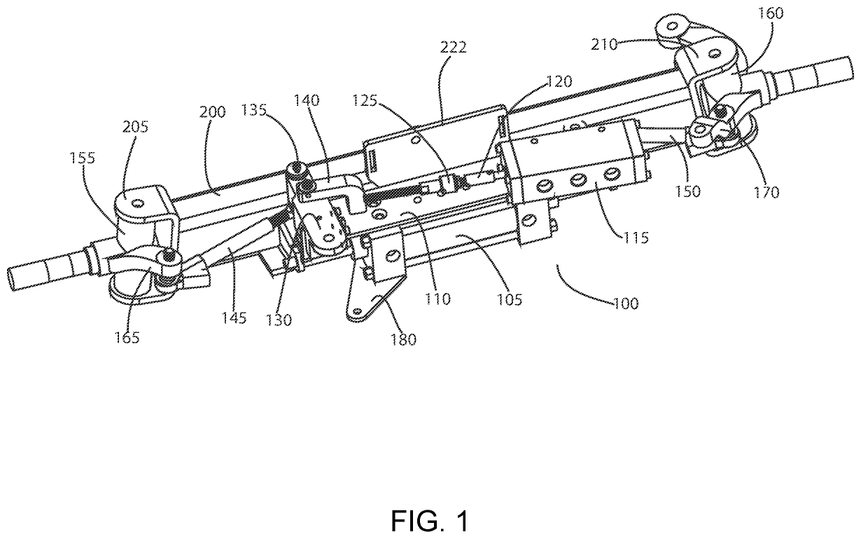

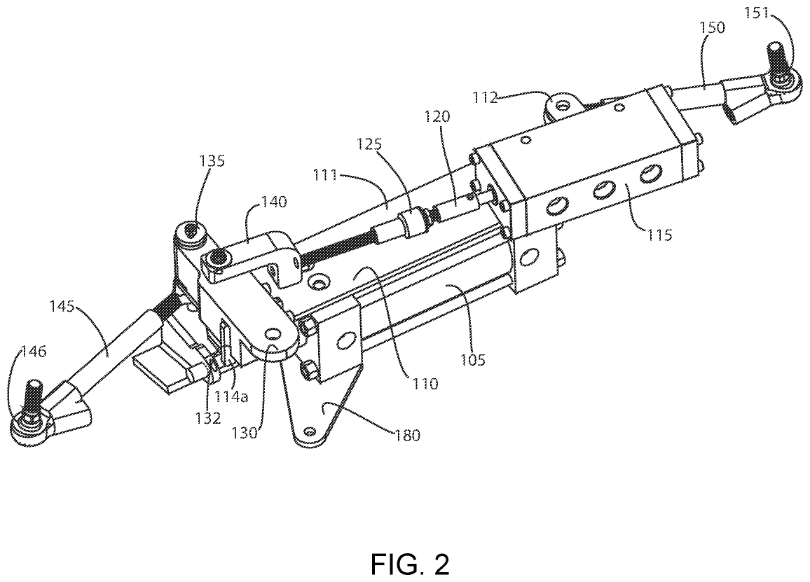

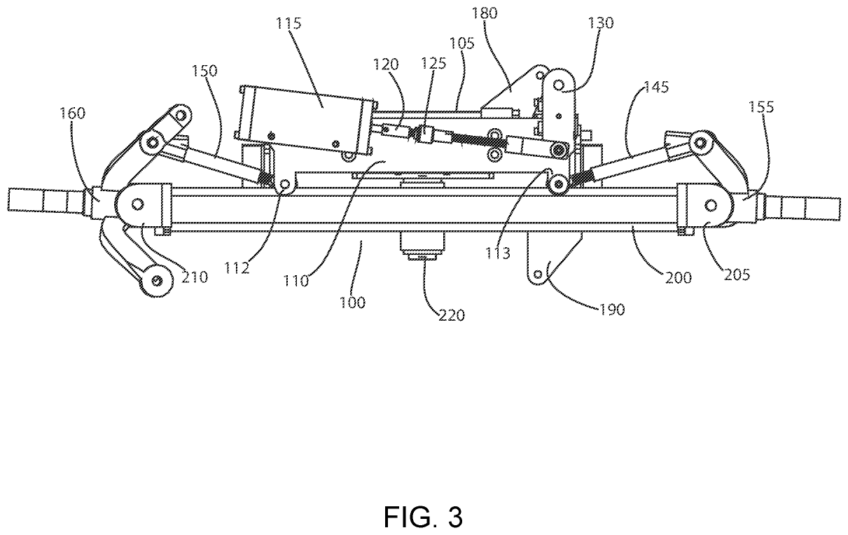

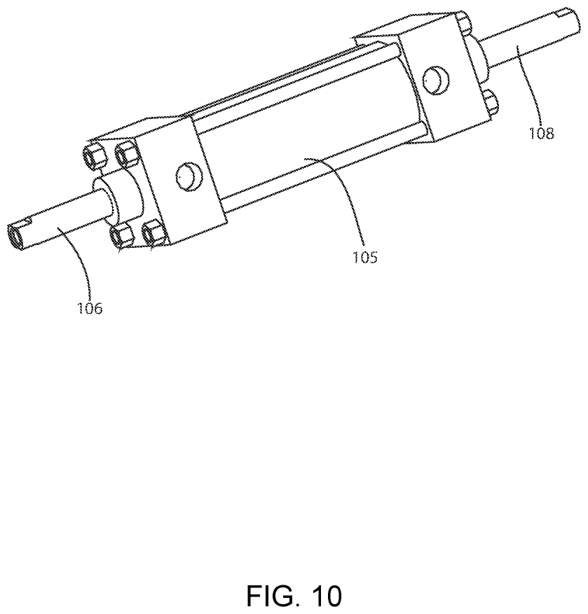

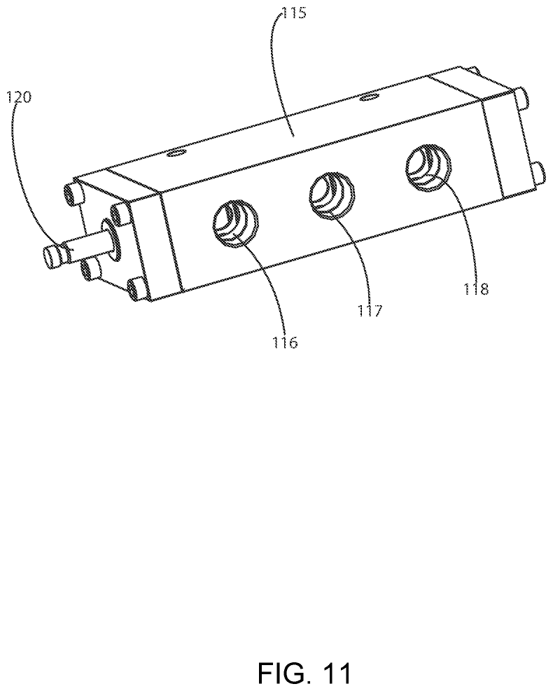

Referring to FIGS. 1-3, an exemplary pneumatic power assist steering system 100 connected to an axle assembly 200 according to principles of the invention, is conceptually illustrated. A double-ended (or through-rod) cylinder 105 (pneumatic cylinder), which includes a plurality of ports, is fluidly coupled to ports 116-118 of a control valve assembly 115 (FIGS. 10-11). The valve assembly 115 is preferably mounted in fixed relation to the cylinder 105. The fluid couplings (e.g., hoses) are omitted from the drawings for clarity. A source of pressurized air supplies pressurized air to the control valve assembly 115. The cylinder 105 contains a piston, to which a rod, i.e., the through-rod, is attached. The rod that extends through the cylinder 105, has two ends, end 106 and end 108. In the exemplary implementation, the ends 106, 108 are fixed relative to the axle assembly 200 (e.g., between brackets extending from the axle assembly) and the cylinder 105 moves linearly relative to the axle assembly 200. As known in the art of pneumatic cylinders, the piston provides a seal within the cylinder, and that seal may move relative to cylinder in response to a pressure differential. If the pressure on one side of the piston is less than on the opposite side, the cylinder 105 will move relative to the rod towards the side with the lower pressure. If the pressure on both sides of the piston is equal, the cylinder 105 will not move relative to the rod.

The difference between the pressures on each side of the piston in the cylinder 105, the pressure differential, is controlled by the control valve assembly 115. The control valve assembly 115 controls the pressure differential in the cylinder 105, and therefore controls motion of the cylinder 105 relative to the rod. The control valve assembly 115 may supply compressed air to each side of the piston and may bleed (i.e. evacuate) compressed air from each side of the piston. Compressed air may be bled from one side, the other side, or both sides. Compressed air may be introduced into one side, the other side, or both sides. The position of the control input of the valve assembly 115 determines whether a side is bled, supplied with compressed air, or sealed. Bled air is evacuated through the valve assembly 115 to the atmosphere. In one exemplary embodiment, the valve assembly 115 includes a control shaft 120 with three positions (e.g., an out position, a neutral position and in-position). The positions (in, out and neutral) are used herein to denote 3 distinct positions, for convenience of reference, and may also be referred to as first, second and third positions, or as distinct positions using other nomenclature. When the control shaft 120 is in the out position, the valve assembly 115 bleeds air from one side of the piston in the cylinder 105. When the control shaft 120 is in the in-position, the valve assembly 115 bleeds air from the other side of the piston in the cylinder 105. When the control shaft 120 is in the neutral position, the valve assembly 115 supplies compressed air unless and until the pressure differential is zero and a threshold pressure is maintained.

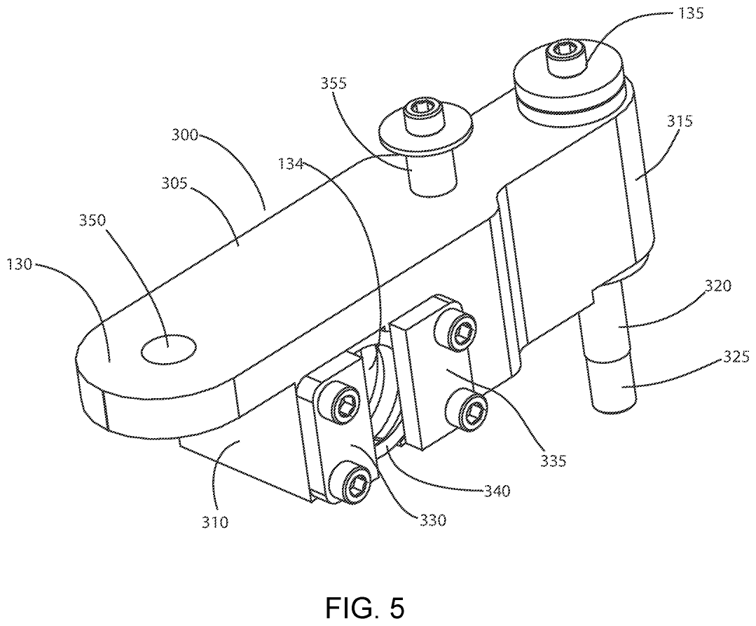

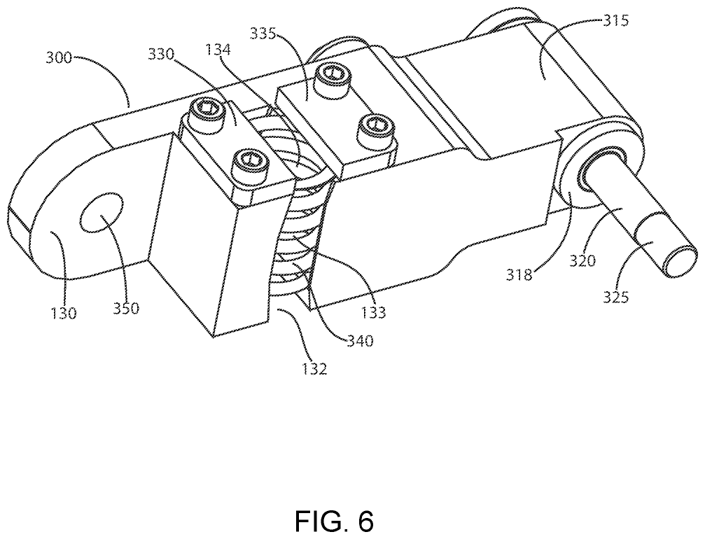

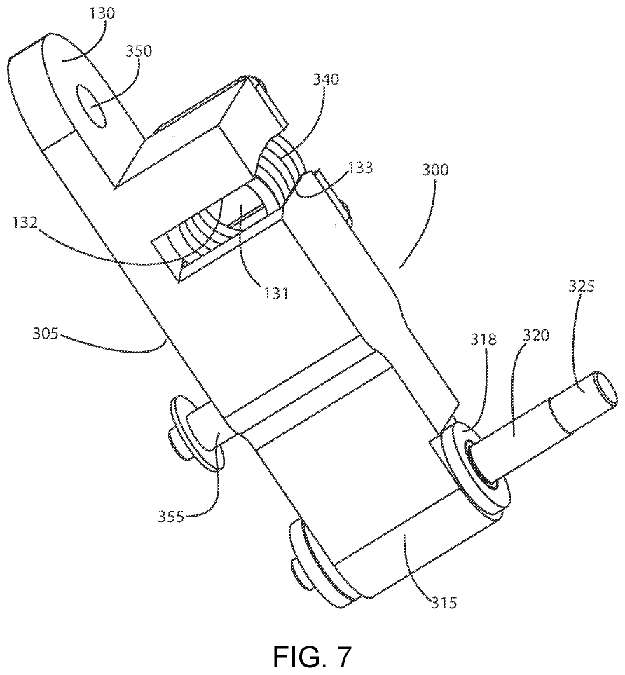

An actuator assembly 300 (FIGS. 5-7) with an actuator arm 130 is pivotally mounted to a cylinder housing mount referred to as a power steering plate 110. The valve assembly 115 may also be mounted to the power steering plate 110, spaced apart from the actuator assembly 300. The actuator assembly 300 pivots about a spindle 135. The spindle 135 is a shaft that defines an axis of pivoting movement. The end of the actuator arm 130 that is opposite the spindle 135, connects to a linkage couple to a steering column. Thus, steering rotation of a steering wheel causes pivoting motion of the actuator arm 130 about the spindle. The actuator assembly 300 includes a pin 355 that is pivotally coupled to an elbow 140 that connects the actuator assembly 300 to a linkage 125 that links the actuator assembly 300 to the control shaft 120 of the control valve assembly 115. Thus, pivoting motion of the actuator arm 130, causes movement of the control shaft 120. Such movement of the control shaft 120 causes the control valve assembly 115 to control the pressure differential in the cylinder 105. Control of the pressure differential in the cylinder 105 controls relative movement (if any) of the cylinder 105.

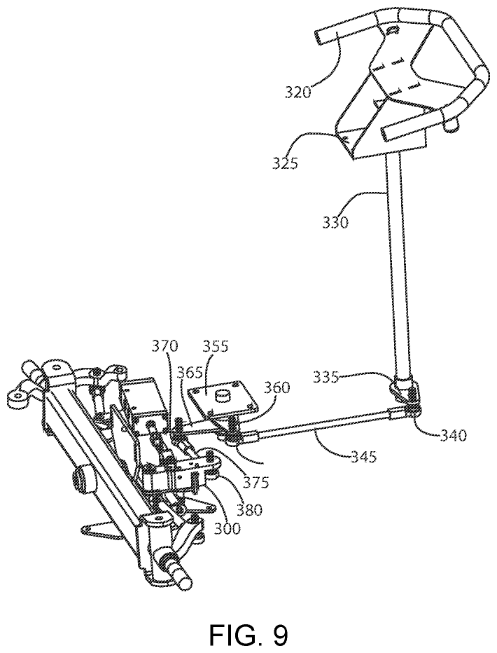

A non-limiting example of a steering linkage for a rear wheel steered vehicle is conceptually illustrated in FIG. 9. A steering wheel or handlebar 320 is mounted to a mount 325. A shaft 330 or steering column extends from the handlebar 320. A lever arm 335 at the distal end of the shaft 330 is connected to a ball joint 340 of a first steering link 345. A pivoting lever arm assembly includes a first lever arm 360 fixed at a right angle to a second lever arm 365. The lever arm assembly pivots relative to a mounting plate 355 which may be attached to a frame or similar components. The second arm 365 is connected by a second steering link 375, with ball joints 370, 380, to the hole 350 in the actuator arm 130 (FIGS. 5-7). Steering rotation of the handlebar causes movement of the linkage elements, which causes the actuator assembly 300 to pivot about spindle 135.

The invention is not limited to the illustrated valve assembly 115. Other valve assemblies capable of controlling the pressure differential in a power assist pneumatic cylinder may be utilized without departing from the scope of the invention. Such other valve assemblies may include other mechanically actuated valve assemblies, with the linkage between the actuator arm 130 and the control input of the valve assembly being adjusted for the particular valve assembly. The linkage provides a mechanical coupling between the actuator arm 130 and the control input of the valve assembly. Alternatively, such other valve assemblies may include an electrically operated control valve. A sensor may detect pivoting motion of the actuator arm and supply input control signals to the electrically operated control valve. By way of example and not limitation, such a sensor may be a rotary motion position sensor, a hall effect sensor with one or more magnets attached to the actuator arm 130, a rotary encoder, or an angular rate sensor.

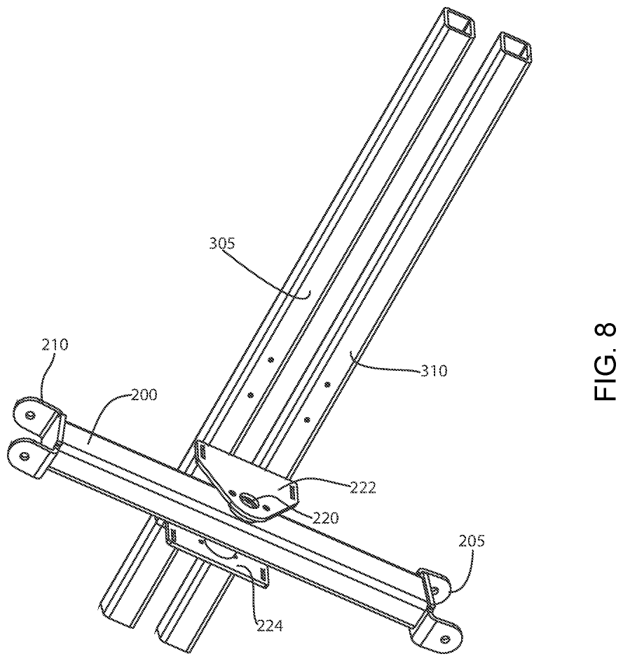

Knuckle brackets 205, 210 are provided at opposite ends of the axle 200. A steering knuckle 155, 160 is pivotally mounted in each knuckle bracket 205, 210. With reference to FIG. 8, the axle 200 is pivotally mounted between opposed plates 222, 224 with a tubular shaft 220 extending between the plates 222, 224. The plates are attached (e.g., bolted) to frame tubes 305, 310. A bearing may be provided in the axle 200 to facilitate rotation about the shaft 220. The principles of the invention are not limited to the specific axle and steering knuckles illustrated in the figures. Axles and knuckles having other configurations may be steered using a power assist system according to principles of the invention.

In the exemplary embodiment, tie rods 145, 150 couple the arm 165, 170 of each knuckle 155, 160 to the power steering plate 110. As the cylinder 105 moves relative to the rod 106, 108, the power steering plate 110 attached to the cylinder 105 moves. As the power steering plate 110 attached to the cylinder 105 moves, the tie rods 145, 150 are moved. One tie rod is pulled while the other tie rod is pushed. Such movement of the tie rods 145, 150 causes pivoting rotation of the steering knuckles 155, 160 about the knuckle brackets 205.

Optionally, to stabilize the cylinder 105 and axle 200, radius arm mounts 180, 190 are provided. Each radius arm may be connected with a rubber or solid bushing to the radius arm mount at one end and to the frame, chassis or unibody of the vehicle at the other end. Thus, the radius arms allow the axle 200 and cylinder to move through their range of travel, while resisting motion in other directions or beyond the range of travel. While the invention may be used with radius arm stabilizers, the invention is not limited to use with any particular radius arm stabilizers or any radius arm stabilizers.

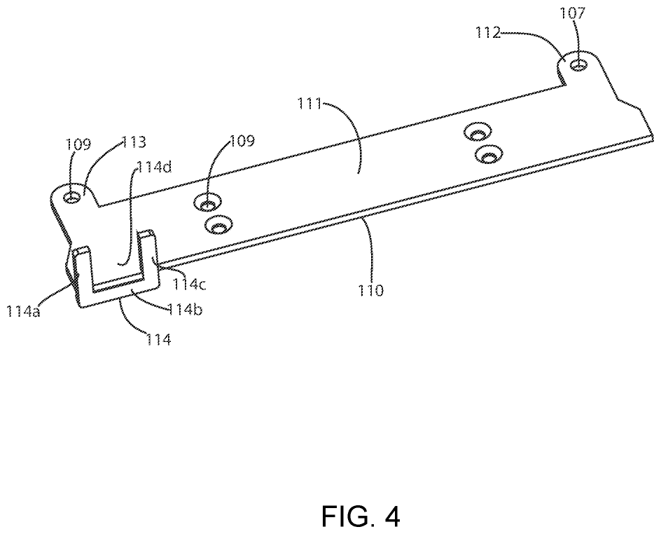

FIG. 4 conceptually illustrates an exemplary cylinder housing mount, i.e., power steering plate 110, for an exemplary pneumatic power assist steering system according to principles of the invention. The power steering plate 110 attaches to the cylinder 105 (i.e., the exterior of the cylinder housing in which the cylinder is contained). As the cylinder 105 moves, so does the power steering plate 110 move. The power steering plate 110 includes holes in the body 111 for bolting the power steering plate 110 to the cylinder 105. A pair of tabs 112, 113 with tie rod mounting holes 107, 109, are provided along an edge, at opposite ends of the body 111. The pair of tabs are aligned with the plane of the body 111 of the power steering plate 110.

An actuator bracket 114 extends perpendicular to the plane of the body 111 of the power steering plate 110. The bracket 114 extends from an edge opposite to the edge from which the tab 113 extends. The bracket includes a base segment 114b with two ends, and an upright segment 114a, 114c extending upwardly from each end, to form a U-shaped structure with a gap 114d between the uprights 114a, 114c. The bracket 114 engages a spring 340 (FIGS. 5-7) in the actuator assembly 300. The bracket 114 is sized, shaped and configured for the uprights 114a, 114c to occupy opposite side slots 132, 134 of the actuator assembly 300, while the base 114b occupies the bottom slot 133 of the actuator assembly 300. The gap 114d is at least equal to the length of the spring 340 in the actuator assembly 300 before the spring 340 is compressed by an upright 114a, 114c. The thickness of each upright 114a, 114c is less than the width of each opposite side slot 132, 134.

FIGS. 5-7 conceptually illustrates an exemplary spring-biased actuator assembly 300 for an exemplary pneumatic power assist steering system according to principles of the invention. A spindle 135 with a medial portion 320 extend through a first end 315 of the actuator assembly 300 and engages the mounting hole 109 in the power steering plate 110. The assembly includes a surface 305 with an arm 130, with a hole 350 for coupling a steering linkage, defining a second end of the actuator assembly 300 opposite the first end 315. The actuator assembly 300 may pivot about the spindle 135 relative to the power steering plate 110. A distal portion 325 of the spindle 135 extends through the mounting hole 109, for engagement by an end of the tie rod 145. While the medial portion 320 of the spindle 135 engages the mounting hole 109, the slots 132-134 of the actuator assembly 300 are flanked by the uprights 114a, 114c. A pair of removable plates 330, 335 provide access to a spring compartment 131 in the bottom 310 of the actuator assembly 300.

The actuator assembly 300 also includes a pin 355 that is pivotally coupled to an elbow 140. The elbow connects the actuator assembly 300 to a linkage 125. The linkage 125 links the actuator assembly 300 to the control shaft 120 of the control valve assembly 115. Steering motion causes pivoting motion of the actuator arm 130. Pivoting motion of the actuator arm 130 causes movement of the control shaft 120. Such movement of the control shaft 120 causes the control valve assembly 115 to control the pressure differential in the cylinder 105. Control of the pressure differential in the cylinder 105 controls relative movement (if any) of the cylinder 105. Concomitantly, pivoting motion of the actuator arm 130 causes the spring 340 to abut one of the uprights 114a, 114c. Interaction between the spring 340 and the upright 114a, 114c, cause the spring 340 to compress. The compressed spring When the steering wheel is held straight, the compression of the spring 340 ceases and the spring 340 returns to an uncompressed state. Upon returning to an uncompressed state, the spring 340 urges the control shaft 120 into a neutral position. When the control shaft 120 is in a neutral position, the valve assembly 115 reduces any pressure differential in the cylinder 105 to zero.

FIG. 9 is a perspective view of an exemplary steering linkage for an exemplary pneumatic power assist steering system according to principles of the invention.

FIG. 10 is a perspective view of an exemplary double acting cylinder with a through rod for an exemplary pneumatic power assist steering system according to principles of the invention.

FIG. 11 is a perspective view of an exemplary valve assembly for an exemplary pneumatic power assist steering system according to principles of the invention.

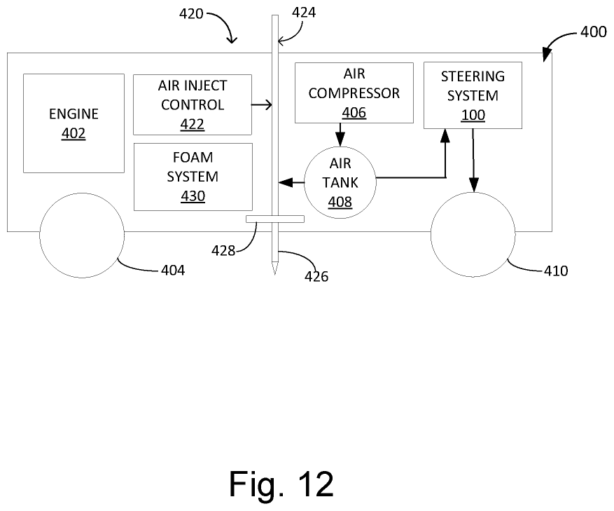

FIG. 12 is a block and schematic diagram generally illustrating a ride-on air injection machine 400 for injecting air into soil, including pneumatic power assist steering system 100, according to one example of the present disclosure. Injecting air into soil decreases compaction of the soil, increases soil porosity, improves drainage, removes trapped gasses and improves root growth of turf. Such air injection is beneficial in many applications including lawns, sod farms, gold courses, and sporting fields, where decreased compaction of the turf and underlying soil helps to ensure that soil hardness is below maximum allowable compression test levels (e.g., below maximum hardness levels set by the National Football League) to thereby reduce the chance for concussions among athletes.

In one example, ride-on machine 400 includes an engine 402 (e.g., an internal combustion engine) for driving at least one front wheel 404 to propel machine 400, and for driving an air compressor 406 to supply compressed air to a compressed air tank 408. In one example, pneumatic power assist steering system 100 is coupled to and controls steering of at least one rear wheel 410, with air compressor 406 (e.g., via compressed air tank 408) providing compressed air to control valve assembly 115 of steering system 100 (see FIG. 1, for example). As described above by FIG. 1-11, control valve assembly 115, in-turn, provides compressed air to cylinder 105 to assist in turning of the at least one rear wheel 410 via control of control shaft 120 of control valve assembly 115 by movement of steering wheel 320 (see FIG. 9). In one example, steering system 100 controls steering of a pair of rear wheels 410. In other examples, steering system 100 controls steering of front wheels 404.

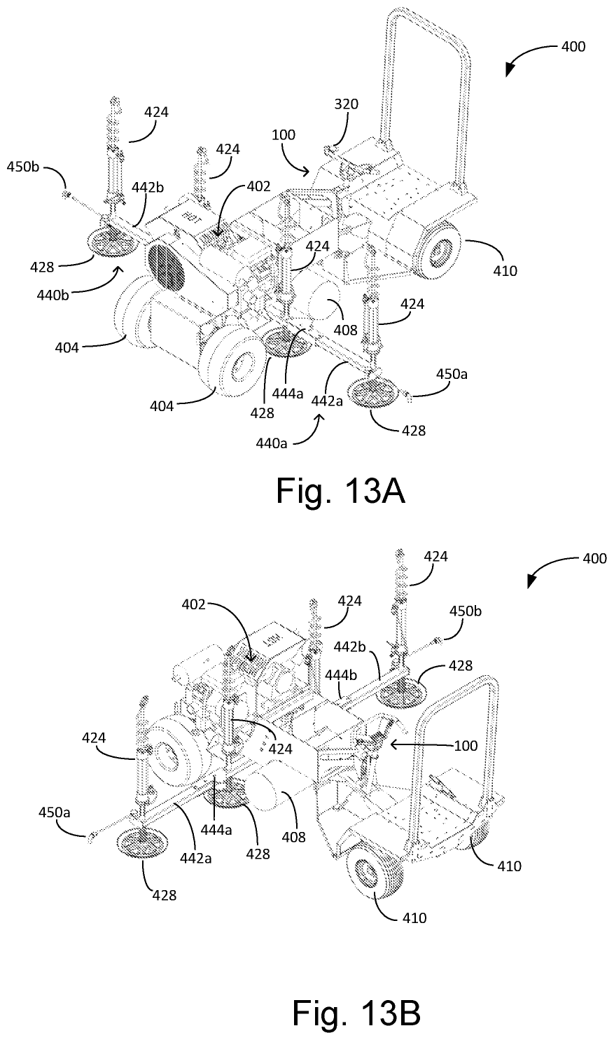

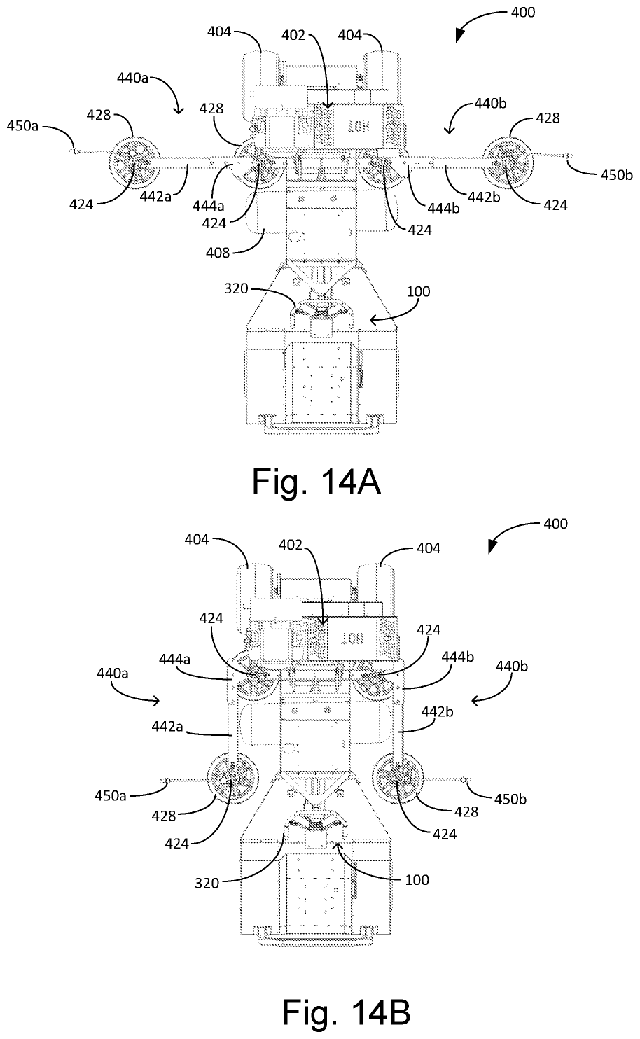

Air inject machine 400 further includes an air inject system 420 having a control unit 422 and one or more air inject shafts 424, with each air inject shaft 424 including a spike or tine 426 for insertion into the ground, and a stabilizer pad 428. In one example, air inject machine 400 includes a set of four air inject shafts 424 (see FIGS. 13-14 below, for example). In operation, air inject control unit 422 controls downward/upward movement of each air inject shaft 424 to insert/retract tine 426 into/out of the ground. In one example, to inject air into the underlying soil, control unit 422 forces air inject shaft 424 downward (e.g., via any suitable drive means, such as pneumatic and hydraulic) such that tine 426 (or insertion tip) is driven into the soil, at which point control unit 422 expels pressurized air from compressed air tank 408 into the soil via openings in tine 426. In one example, compressed air from compressed air tank 408 travels through passages within an interior of at least a portion of air inject shaft 424 (e.g., at least within tine 426). In one example, when in a retracted position, where tine 426 is withdrawn from the soil, tine 426 is biased upward (e.g., by a bias spring) so as to be disposed within a hollow portion of air inject shaft 424 (see FIGS. 13A-B). When air inject shaft 424 is moved downward to drive tine 426 into the soil, stabilizer pad 428 contacts the ground and serves a base to stabilize air inject shaft 424 when pushing tine 426 into the soil.

In one example, as a user drives air inject machine along a desired path, air inject shafts 424 are moved by control unit 422 to a raised or retracted position. Upon reaching a desired air injection site, air machine 400 is stopped and control unit 422 (such as via a user operated control input) drives air inject shafts 424 downward to force tine 426 into the soil. Compressed air from compressed air tank 408 is then injected into the soil via insertion portion 426. In one example, air is first injected into the soil from a first set of openings in tine 426 that are at a first depth, and then injected into the soil from a second set of openings in tine 426 that are at a second depth. In one example, the first depth is less than the second depth. Injecting air into the soil reduces soil compaction, increases soil porosity, and enhance respiration to enable water to drain easily and promote gas exchange with minimal disturbance to the overlying turf and roots and without soil cores. In one example, upon completion of air injection into the soil, air injection shafts 424 are raised, and air injection machine 400 is driven to a next air injection site by a user, where steering is controlled via pneumatic power assist steering system 100, and the above process repeated.

In one example, as air inject machine 400 is driven along a path, foam system 430 drops foaming bubble markers onto the ground to mark the path to identify the area where air has been injected into the soil. In one example, foam system 430 is configured to drop a foam bubble marker each time air inject shafts 424 are inserted into the ground. In one example, foam system 430 is configured to drop foam bubble makers at intervals as air inject machine 400 is driven. In one example, foam system 430 drops foam markers based on user input. In one example, foam system 430 may employ compressed air from compressed air tank 408.

FIGS. 13A and 13B respectively illustrate front and rear perspective views of ride-on air inject machine 400, according to one example. In the illustrated embodiment, air inject machine 400 includes a pair of air inject booms 440a and 440b extending from opposite sides of air inject machine 400. In one example, each air inject boom 400 includes a pair of laterally spaced apart air inject shafts 424 for injecting air into the underlying soil. In one example, end portions 442a and 442b of air inject booms 440a and 440b pivot about pivot about corresponding hinge mechanisms 444a and 444b to enable end portions 442a and 442b to be pivoted to a retracted position (e.g., substantially parallel to the side of machine 400) when not in use (see FIGS. 14A-B). In one example, foam ejection nozzles 450a and 450b of foam system 430 are respectively disposed as distal ends of air inject booms 440a and 440b.

FIGS. 14A and 14B respectively illustrate air inject booms 440a and 440b in extended and retracted positions.

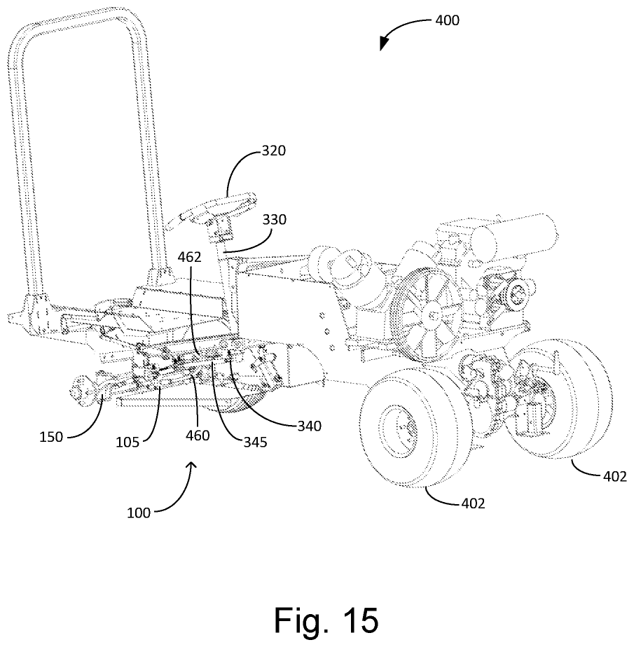

FIG. 15 is a perspective view of ride-on air inject machine 400, where portions of air inject machine 400 have been removed to better illustrate pneumatic power assist steering system 100, according to one example. Movement of steering wheel 320 controls steering of rear wheels 410 via right and left side steering knuckles 150 and 160 (only 150 is shown in FIG. 15). Air from compressed air tank 408 is supplied to opposing internal chambers of cylinder 105 from control valve 115 via air connections 460 and 462 (e.g., hoses). Although illustrated as controlling a pair of rear wheels, in other examples, pneumatic power assist steering system 100 may be adapted to control a single rear wheel, a single front wheel, or a pair of front wheels.

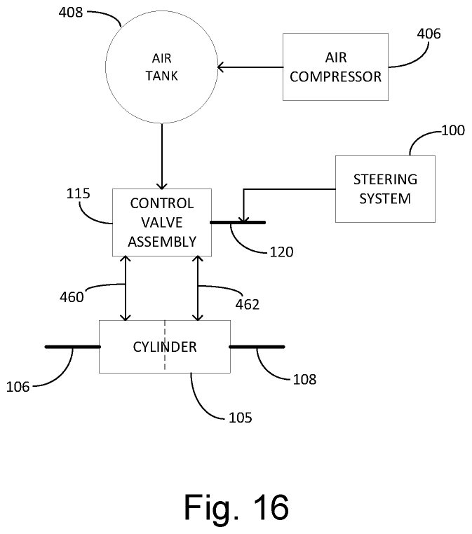

FIG. 16 is a block and schematic diagram generally illustrating pneumatic power assist steering system 100, according to one example. Air compressor 406 provides compressed air to compressed air tank 408, which in turn supplies compressed air to control valve assembly 115. As described above, control valve assembly selectively provides compressed air to, or bleeds compressed air from, opposing chambers of cylinder 105 (such as via air paths 460 and 460, e.g., hoses) to move cylinder 105 back and forth between rod ends 106 and 108 (where rod ends 106 and 108 are fixed to a frame of air inject machine 400) based on a position of control shaft 120, where the position of control shaft 120 is controlled by the position of steering wheel 320. As described above, a linkage system couples cylinder 105 to the wheel(s) of air inject machine 400 (e.g., front wheels 404), where movement of cylinder 106 between rod ends 106 and 108, in turn, controls the position of the wheel(s) to steer air inject machine 400.

Using compressed air already present on air inject machine 400 for the injection of air into soil to also provide pneumatic power to steering system 400 is a cost effective method to provide power steering to air inject machine 400 as it eliminates the need for a separate hydraulic fluid system, which in-turn, eliminates the use of hydraulic fluid for such conventional power steering systems, where hydraulic fluid kills grass and, thus, is not desirable for use on sporting fields, golf courses, sod farms, etc.

While exemplary embodiments of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A ride on air injection machine comprising:
one or more steerable wheels;
a compressed air system providing compressed air;
one or more air inject tines to inject compressed air from the compressed air system into the ground; and
a steering system including:
a steering wheel;
a cylinder coupled to the steerable wheels, the cylinder including opposing internal chambers and being moveable to steer the steerable wheels; and
a control valve assembly to direct compressed air from the compressed air system to the internal chambers and to bleed compressed air from the internal chambers based on a position of the steering wheel to move the cylinder to steer the steerable wheels.

2. The ride on air inject machine of claim 1, the cylinder moveable back and forth along a cylinder rod, the cylinder in mechanical communication with the steerable wheels.

3. The ride on air inject machine of claim 1, the compressed air system including:
a compressed air storage tank; and
an air compressor to provide compressed air to the storage tank.

4. The ride on air inject machine of claim 3, the control valve assembly to direct air from the compressed air tank to the cylinder.

5. The ride on air inject machine of claim 1, the control valve including a moveable control shaft, where the supplying of compressed air to the internal chambers of the cylinder and the bleeding of compressed air from the internal chambers of the cylinder is based on a position of the control shaft, where the steering wheel is coupled to the control shaft by a mechanical linkage.

6. The ride on air inject machine of claim 1, including a foam system to drop foaming bubbles to mark a traveled pathway of the air inject machine.

7. The ride on air inject machine of claim 1, the air inject tines disposed on retracting booms extending from opposing sides of the air inject machine.

8. A ride on air inject machine comprising:
one or more steerable wheels;
a compressed air system to provide compressed air;
a plurality of ground insertable air inject tines to inject compressed air from the compressed air system below a surface of the ground; and
a pneumatic power assist steering system to receive compressed air from the compressed air, the compressed air to assist with steering of the steerable wheels.

9. The ride on air inject machine of claim 8, the compressed air system including a compressed air storage tank and an air compressor to provide compressed air to the storage tank, the pneumatic power assist steering system to receive compressed air from the compressed air storage tank.

10. The ride on air inject machine of claim 9, including an internal combustion engine to drive one or more drive wheels of the air inject machine to propel the air inject machine, and to power the air compressor.

11. The ride on air inject machine of claim 9, the pneumatic assist power steering system including a pneumatic piston to receive compressed air to turn the one or more steerable wheels based on an input from a steering wheel of the ride on air inject machine.

12. The ride on air inject machine of claim 11, the pneumatic assist power steering system including a control valve assembly including a control shaft mechanically coupled to the steering wheel, wherein movement of the steering wheel causes movement of the control shaft to control compressed air pressure provided to the piston to control movement of the one or more steerable wheels.

13. The ride on air inject machine of claim 12, the piston comprising a double-ended piston having a cylinder moveable back and forth along a piston rod based on a differential pressure between a pair of opposing internal air chambers, wherein the control valve assembly controls the differential air pressure based on movement of the steering wheel.

14. The ride on air inject machine of claim 13, the piston rod fixed relative to the ride on air inject machine, wherein the cylinder is mechanically coupled to the one or more steerable wheels, and wherein movement of the cylinder along the piston rod controls movement of the one or more steerable wheels.

15. A pneumatic steering system for a turf maintenance machine having at least one steerable wheel, the pneumatic steering system comprising:
a piston including:
a piston rod; and
a cylinder disposed about the piston rod, the cylinder in mechanical communication with the at least one steerable wheel, the cylinder having a pair of opposing internal chambers to hold compressed air, based on a differential in pressure between compressed air held in the opposing internal chambers, the cylinder to move back and forth along the piston rod to steer the at least one steerable wheel.

16. The pneumatic steering system of claim 15, further including:
a control valve assembly to:
receive compressed air from a compressed air supply; and
to control the differential pressure by providing compressed air from the compressed air supply to the opposing internal chambers or removing compressed air from the opposing internal chambers based on a position of a steering mechanism of the ride-on turf maintenance machine.

17. The pneumatic steering system of claim 16, the control valve assembly including a moveable control shaft to control the differential pressure, the moveable control shaft coupled to the steering mechanism via a mechanical linkage.

18. The pneumatic steering system of claim 17, the control shaft moveable between three positions, the control shaft to provide more air pressure in a first one of the internal chambers than a second one of the internal chambers when in a first position, to provide more air pressure in the second one of the internal chambers than the first one of the internal chambers when in a second position, and to equalize air pressure between the first and second internal chambers when in a third position.

19. The pneumatic steering system of claim 15, further including:
an axle assembly including at least one pivoting knuckle to couple to the at least one steerable wheel, the cylinder in mechanical communication with the at least one pivoting knuckle via at least one tie rod, where movement of the cylinder causes pivoting on the at least one pivoting knuckle via the tie rod to steer the at least one steerable wheel.

20. The pneumatic steering system of claim 15, the pneumatic steering system including a compressed air supply.
